(19) United States
(12) Patent Application Publication
(10) Pub. No.: US 2023/0338759 A1
(43) Pub. Date: Oct. 26, 2023

(54) SYSTEMS, METHODS, AND DEVICES FOR EARLY WILDFIRE DETECTION

(71) Applicant: SenseNet Inc., Vancouver (CA)

(72) Inventors: Hamed Noori, Vancouve (CA); Shahab Bahrami, Vancouve (CA)

(21) Appl. No.: 18/304,123

(22) Filed: Apr. 20, 2023

Related U.S. Application Data
(60) Provisional application No. 63/333,089, filed on Apr. 20, 2022.

(51) Int. Cl. A62C 3/02; G08C 17/02

(52) U.S. Cl. CPC A62C 3/0271; G08C 17/02

(57) ABSTRACT

A system, method, and device for detection and monitoring are provided. The detection system includes data collecting devices in a detection network, the devices including a wireless communication module to connect to the detection network, operate in network protocols, provide time synchronization for transmission of environmental data, and transmit the environmental data. The device includes a power processing module configured to activate a sensor assembly based on the time synchronization and communicate the environmental data from the sensor assembly to the wireless communication module. The device further includes a power supply assembly configured to provide electrical power to the device including a power source and a power management circuit, the power source including a rechargeable battery and a non-rechargeable battery, the rechargeable battery serving as a power source until an energy level of the rechargeable battery reaches a predetermined limit, and the non-rechargeable battery serving as a power source.

### TECHNICAL FIELD

The following relates generally to wildfire detection, and more particularly to systems, methods, and devices for early detection and monitoring of wildfires.

### INTRODUCTION

Wildfires pose numerous dangers to human life, to the environment, and to property. Wildfires may be deadly for both humans and animals alike. Wildfires present particular risks of people becoming trapped by rapidly moving flames or succumbing to smoke inhalation and wildlife not being able to escape or find suitable habitats thereafter. Wildfires may cause extensive damage to residential and commercial properties, infrastructure, and agricultural lands, resulting in significant financial losses for individuals, businesses, and governments.

Significant environmental devastation may also result from wildfires. Such devastation includes damage to forests, grasslands, and other ecosystems due to the loss of vegetation. Such loss of vegetation leads to soil erosion, reduced water quality, and an increased risk for landslides and flooding in affected areas. Smoke from wildfires may significantly reduce air quality, leading to respiratory problems and other health concerns for people and animals alike. Fine particulate matter (PM_{2.5}) and other pollutants are able to travel long distances, impacting air quality even far away from where wildfires have occurred. Furthermore, wildfires release large amounts of carbon dioxide (CO₂) and other greenhouse gases into the atmosphere, contributing to climate change.

Early wildfire detection is essential as a means of preserving human life and protecting the environment by allowing for quicker responses and better management of wildfires. Early detection of wildfires allows firefighting crews to act more quickly, potentially responding to a wildfire before the wildfire spreads out of control. Such response helps minimize overall damage to human life, to the environment, and to property. Furthermore, firefighting authorities may be able to allocate resources more effectively to where they are most needed. Such allocation may result in a more efficient use of personnel, equipment and financial resources and may help preserve human life.

Fighting wildfires before they spread may advantageously help defray overall firefighting expenses, as smaller fires tend to be less expensive and resource-intensive to extinguish than larger, out-of-control wildfires. When wildfires are detected early, authorities have more time to issue evacuation orders and guarantee residents in affected areas are safely evacuated. This additional time advantageously mitigates injuries and fatalities by giving people enough time to prepare and leave their homes safely. Furthermore, early detection allows for faster alerts about air quality and smoke-related health hazards. Such faster alerts may help individuals with respiratory conditions such as asthma or other lung diseases take precautions and minimize exposure to hazardous pollutants. Moreover, early detection may facilitate protecting critical infrastructure such as power lines, roads, and communication networks, decreasing the likelihood of widespread service disruptions and repairs that would incur costs. Early detection may further lead to faster containment, advantageously minimizing the environmental effects of wildfires such as soil erosion, water pollution, and loss of biodiversity.

A variety of wildfire detection systems are known and utilized to detect and monitor wildfires. Presently, networks of ground-based sensors installed in fire-prone areas may detect changes in smoke or temperature indicators that might indicate the presence of a fire. Known ground-based sensors for stationary wildfire surveillance systems have limitations including limited coverage for star topologies, significant power consumption, and limited scalability. Expanding the coverage of stationary systems, particularly of star topologies, can be costly and time-consuming, as such expansion requires the installation of additional sensors, cameras, or towers. Furthermore, stationary systems may have difficulty detecting fires with certain characteristics, such as low-intensity fires, fires beneath tree canopies, or fires in areas with highly variable temperatures. Traditional wildfire detection techniques may be used to scan very large areas of land, but may not detect flames at early stages unless in a direct line of sight.

Moreover, the network protocols and sensor topologies used by known ground-based sensors, such as star topologies, consume significant power, thereby leading to costly maintenance. Network protocols such as Wi-Fi™, Bluetooth™ 3G/4G/5G Cellular Networks, and Ethernet™ consume high power due to higher transmission power and complex protocol overhead.

For ground-based sensors, star or mesh network topologies may be used. In a star network topology, all nodes (devices) are connected to a central hub or switch. The central hub manages the connections and communication between nodes. Data transmitted by a node must pass through the central hub or switch before reaching its destination. However, dependence on the central hub adds limitations to the star network topology. The limitations include reduced scalability, higher failure risk to the network if the central hub fails, i.e., a single point of failure, and higher cost. Comparatively, in the mesh network topology, the nodes are interconnected, with each node potentially having multiple connections to other nodes. Data may be transmitted along multiple paths, providing redundancy and fault tolerance. However, known systems for wildfire detection organized according to a mesh topology consume significant power as the antenna of each sensor stays active a large number of connections between nodes.

Satellites, aerial imaging methods, and stationary surveillance methods may be used to scan very large areas of land but may not detect flames at early stages unless in a direct line of sight and may not be able to recognize early-stage wildfires at all. In particular, satellite-based systems for wildfire detection rely on orbits of satellites for coverage, which may cause gaps in coverage or delays in data acquisition for certain areas. Moreover, aerial systems relying on flying vehicles, such as drones, may be temporally limited, as drones and like devices have limited flight durations.

Accordingly, networks, methods, and devices are desired that overcome one or more disadvantages associated with existing wildfire detection and monitoring systems.

### SUMMARY

A detection system is provided. The detection system includes a plurality of data collecting devices in a detection network, the data collecting device including a wireless communication module configured to connect to the detection network, operate in any one of a plurality of network protocols, provide time synchronization for transmission of environmental data, and transmit the environmental data. The system further includes a power processing module configured to activate a sensor assembly at a preset sensor time period based on the time synchronization and, according to the time synchronization, communicate the environmental data from the sensor assembly to the wireless communication module. The system further includes the sensor assembly configured to collect the environmental data. The system further includes a power supply assembly configured to provide electrical power to the data collecting device, the power supply assembly including a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit.

The network protocol may be automatically selected based on a location of the data collecting device and/or a received network protocol received from another data collecting device.

The non-rechargeable battery may serve as the second power source until the rechargeable battery is recharged such that the energy level is not at the predetermined limit.

The detection system may further include at least one network gateway configured to provide a communication interoperability interface between the plurality of network protocols and a network server for providing network services including data processing, storage, application and device management, and resource sharing, the network server connected to the at least one network gateway. The plurality of network protocols may include any one or more of a LoRa (Low Range) network protocol and a LoRaWAN (Low Range Wide Area Network) network protocol. The environmental data may relate to the presence or absence of a wildfire. The sensor assembly may include a filter configured to improve measurement accuracy, the filter configured as any one or more of a bandpass filter, a neutral density filter, a chemical filter, and a particulate filter.

The time synchronization may include any one or more of duty cycling, time-slotted communication, coordinated sensing, power-efficient routing, and reduced idle listening.

The sensor assembly may include a plurality of sensors configured to detect the environmental data, the environmental data relating to any one or more of carbon dioxide, carbon monoxide, nitrogen dioxide, temperature, and humidity.

The wireless communication module may be configured to operate in any one of a plurality of operation modes including a LoRa end-node, a LoRaWAN end-node, a LoRa repeater mode, and a LoRa to LoRaWAN mode based on the received network protocol of the other data collecting device.

A detection method is provided. The detection method includes providing a plurality of data collecting devices to connect to a detection network, the plurality of data collecting devices configured to operate in any one of a plurality of network protocols, time synchronizing for transmission of environmental data, activating the data collecting device based on the time synchronizing, collecting, through the data collecting device, the environmental data, providing electrical power to the data collecting device including providing a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit, and transmitting the environmental data.

The method may further include automatically selecting the network protocol based on a location of the data collecting device and/or a received network protocol received from another data collecting device.

The non-rechargeable battery may serve as a second power source until the rechargeable battery is recharged such that the energy level is not at the predetermined limit.

The detection method may further include providing a communication interoperability interface between the plurality of network protocols and providing network services including data processing, storage, application and device management, and resource sharing. The plurality of network protocols may include any one or more of a LoRa (Low Range) network protocol and a LoRaWAN (Low Range Wide Area Network) network protocol. The environmental data may relate to the presence or absence of a wildfire.

The time synchronization may include any one or more of duty cycling, time-slotted communication, coordinated sensing, power-efficient routing, and reduced idle listening.

The data collecting device may include a plurality of sensors configured to detect the environmental data, the environmental data relating to any one or more of carbon dioxide, carbon monoxide, nitrogen dioxide, temperature, and humidity.

The data collecting device may be configured to operate in any one of a plurality of operation modes including a LoRa end-node, a LoRaWAN end-node, a LoRa repeater mode, and a LoRa to LoRaWAN mode based on the received network protocol received from the other data collecting device.

A detection device is provided. The detection device includes a wireless communication module configured to connect to a detection network, operate in any one of a plurality of network protocols, provide time synchronization for transmission of environmental data, and transmit the environmental data. The detection device further includes a power processing module configured to activate a sensor assembly at a preset sensor time period based on the time synchronization and, according to the time synchronization, communicate the environmental data from the sensor assembly to the wireless communication module. The detection device further includes the sensor assembly configured to collect the environmental data. The detection device further includes a power supply assembly configured to provide electrical power to the detection device, the power supply assembly including a power source and a power management circuit, the power source including a rechargeable battery and a non-rechargeable battery, the rechargeable battery serving as a first power source until an energy level of the rechargeable battery reaches a predetermined limit according to the power management circuit, and the non-rechargeable battery serving as a second power source when the energy level is at the predetermined limit.

The network protocol may be automatically selected based on a location of the detection device in the network and/or a received network protocol received from another detection device. The plurality of network protocols may include any one or more of a LoRa (Low Range) network protocol and a LoRaWAN (Low Range Wide Area Network) network protocol.

The non-rechargeable battery may serve as the second power source until the rechargeable battery is recharged such that the energy level is not at the predetermined limit.

The time synchronization may include any one or more of duty cycling, time-slotted communication, coordinated sensing, power-efficient routing, and reduced idle listening.

The sensor assembly may include a plurality of sensors configured to detect the environmental data, the environmental data relating to any one or more of carbon dioxide, carbon monoxide, nitrogen dioxide, temperature, and humidity.

The wireless communication module may be configured to operate in any one of a plurality of operation modes including a LoRa end-node, a LoRaWAN end-node, a LoRa repeater mode, and a LoRa to LoRaWAN mode based on the received network protocol received from the other detection device.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 is a schematic diagram illustrating a system for early detection and monitoring of wildfires, according to an embodiment;

FIG. 2 is a simplified block diagram of components of a device, according to an embodiment;

FIG. 3 is a block diagram of a data collecting device for early detection and monitoring of wildfires, according to an embodiment;

FIG. 4 is a flow diagram of a method for early detection and monitoring of wildfires, according to an embodiment;

FIG. 5 is a top view of a system for early wildfire detection in deployment, according to an embodiment; and

FIG. 6 is a flow diagram of a detection method, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs may be implemented in assembly or machine language, if desired. In any case, the language may be a compiled or interpreted language. Each such computer program is preferably stored on a storage medium or a device readable by a general- or special-purpose programmable computer for configuring and operating the computer when the storage medium or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms, or the like may be described (in the disclosure and/or in the claims) in a sequential order, such processes, methods, and algorithms may be configured to work in alternate orders. Accordingly, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device or article (whether or not they cooperate) may be used in place of a single device or article. Similarly, where more than one device or article is described herein (whether or not they cooperate), it will be readily apparent that a single device or article may be used in place of the more than one device or article.

The following relates generally to wildfire detection, and more particularly to systems, methods, and devices for early detection and monitoring of wildfires.

Wildfire detection systems are essential tools for forest and wildlife management agencies. Early detection and containment of wildfires advantageously minimizes damage to ecosystems and protects endangered species. Early wildfire detection systems are designed to identify and pinpoint the location of wildfires in their early stages, before wildfires become too large and uncontrollable. By recognizing wildfires at an early stage, early wildfire detection systems provide invaluable data to firefighters and emergency response units so that they can act swiftly and decisively.

Early detection of wildfires also helps maximize resource allocation for firefighting operations, enabling authorities to prioritize their response and deploy personnel and equipment strategically. Such allocation ensures that efforts are focused on the most critical areas, preventing the spread of wildfires and minimizing overall costs associated with suppression efforts.

Furthermore, early wildfire detection systems are essential in safeguarding public health by issuing timely alerts about air quality and smoke-related health hazards. This information allows those with respiratory conditions to take necessary precautions to reduce their exposure to hazardous air pollutants. Moreover, these systems provide invaluable data to researchers and fire management agencies to better comprehend wildfire behavior, create more efficient firefighting tactics, and enhancing prevention measures. As such, early wildfire detection systems play a pivotal role in helping minimize damage caused by wildfires while safeguarding environments, communities, and vital infrastructure for present and future generations. Paramount among the advantages of early wildfire detection systems, methods, and devices according to the present invention is the increased preservation of human life.

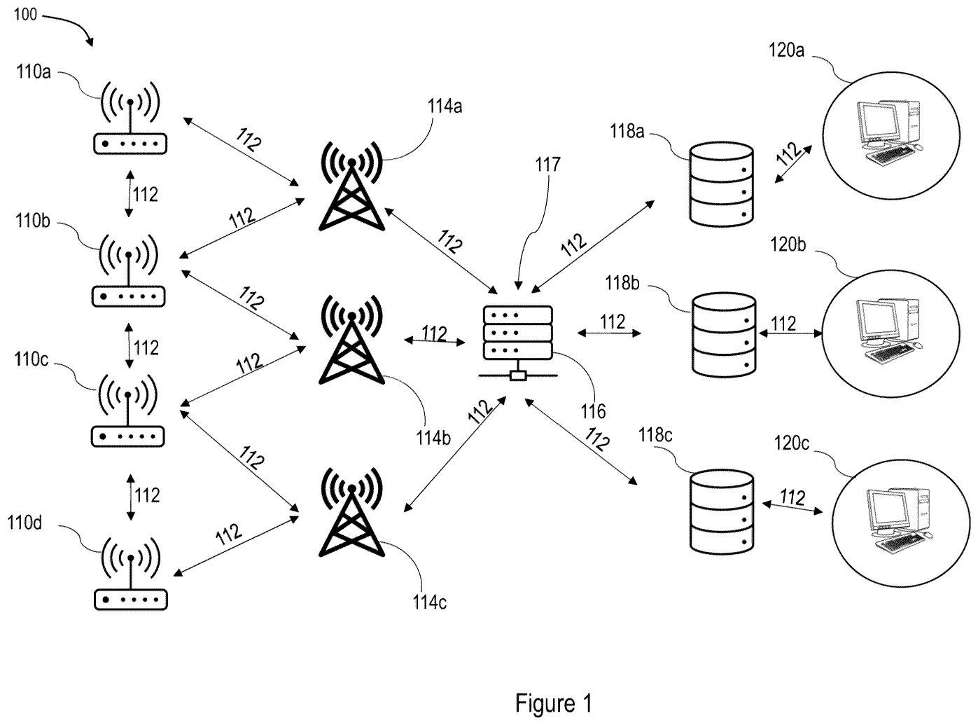

Referring now to FIG. 1, shown therein is a schematic diagram illustrating a system 100 for early detection and monitoring of wildfires, according to an embodiment.

The system 100 includes a plurality of data collecting devices 110a, 110b, 110c, and 110d (collectively referred to as the data collecting devices 110 and generically referred to as the data collecting device 110), a network 112 to provide communication between the components of the system 100, a plurality of network gateways 114a, 114b, 114c (collectively referred to as the network gateways 114 and generically referred to as the network gateway 114) to provide an interface and network services between different network protocols and technologies, a network server 116 to provide network services including data processing, storage, application and device management, and resource sharing, a plurality of application servers 118a, 118b, 118c (collectively referred to as the application servers 118 and generically referred to as the application server 118), a plurality of terminals 120a, 120b, 120c (collectively referred to as the terminals 120 and generically referred to as the terminal 120) for running wildfire detection applications, and a processing station 117 (not shown) for providing data services.

The data collecting devices 110 may be connected to one another through the network gateways 114 or the network 112 to transmit data. The data collecting devices 110 may be further connected to the network server 116 through the network gateways 114 to provide data transmission and interoperability between different network protocols of devices.

The network 112 may be configured as a wired, wireless, or hybrid (partially wired and wireless) network based on a type of communication links used for connecting devices. The wired network 112 may include physical cables, such as Ethernet™ cables, to connect components in the system 100. The wireless network 112 may include Wi-Fi™, Wi-Max™, radio-frequency identification (RFID), or Bluetooth™ functionality to connect components in the system 100. The hybrid network may include a combination of wired and wireless networks. Ethernet™ connections may be made between switches and routers (not shown) to provide wireless connections between the terminals 120 using wireless connections.

The network 112 may be a Low Power Wide Area Network (LPN) configured to include multiple network protocols such as LoRa and/or LoRaWAN protocols. A LoRa protocol is a network protocol that utilizes low-power and long-range wireless technology within a wireless spectrum. A LoRaWAN protocol is an open, cloud-based protocol that enables devices to communicate wirelessly with LoRa. The LoRaWAN protocol uses a LoRa modulation technique to enable low data rate communication over long distances while minimizing power consumption.

The network gateways 114 may be configured to provide communication between networks or devices with different protocols, for example between the network 112 and the data collecting device 110a when the former is using the LoRa protocol and the latter is using the LoRaWAN protocol. The network gateway 114 may provide protocol conversion service, allowing networks 112 with different architectures and communication standards to connect and transmit data. The network gateway 114 may be configured to translate and convert data between different network protocols, such as LoRa and LoRaWAN. Furthermore, the network gateway 114 may be configured to perform address translation (for example, Network Address Translation (NAT) service, data filtering and security, and routing and traffic management).

The network gateways 114 may provide a communication link between wireless communication modules in the data collecting devices 110 and the processing station 117. Furthermore, the network gateways 114 may provide data processing such as filtering, compression or validation to optimize data transmission.

The plurality of low-power data collecting devices 110 configured for ultra-early wildfire detection.

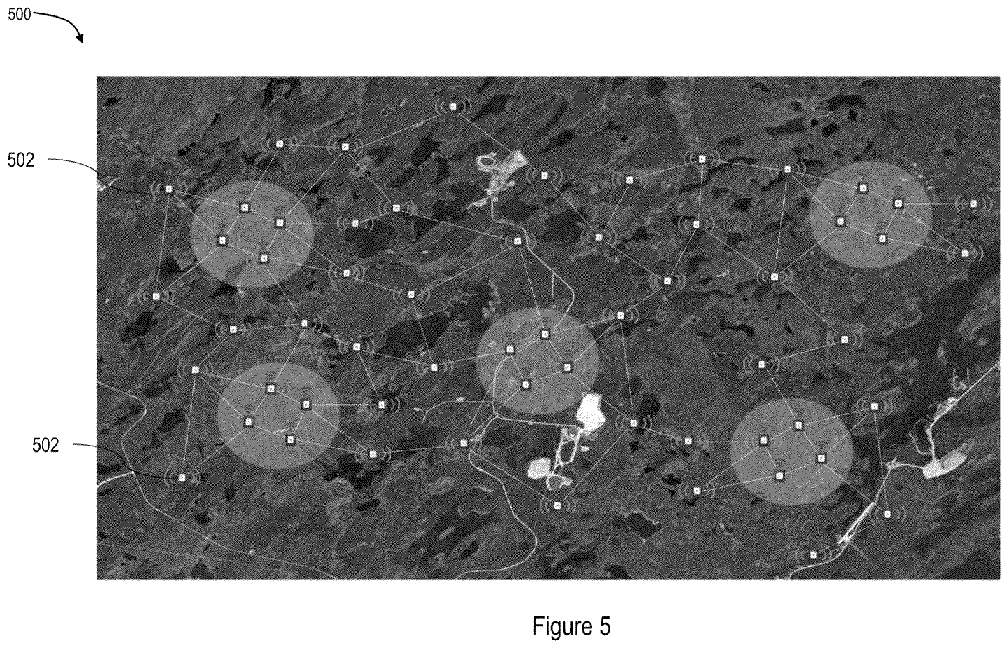

The data collecting devices 110 are organized or arranged according to a mesh topology (see FIG. 5). Advantageously, the mesh network topology provides higher resilience, decentralization, and scalability. In event of a failure or damage to one device 110, data may be transmitted to the gateway 114 through alternative paths. Such data may include environmental data, i.e., data sensed by a device with respect to the external environment about the device. Further, additional data collecting devices 110 may be added to the system 100 without significant network reconfiguration. According to an embodiment, the data collecting devices 110 are optimized for reduced power consumption through time synchronization techniques. Techniques including duty cycling, time-slotted communication, coordinated sensing, power-efficient routing, and reduced idle listening may be used. The data collecting devices 110 are configured to activate data collection, reception, and transmission at predefined time schedules, and alternatively enter low-power inactive modes. Furthermore, the data collecting device 110 may be synchronized with other devices 110 to provide coordinated sensing and power-efficient routing.

According to an embodiment, each data collecting device 110 connects to at least one other data collecting device 110. The data collecting devices 110 may be connected to other data collecting devices 110 through the network gateways 114 or directly. In an embodiment, each data collecting device 110 is connected to at least one other data collecting device 110. The data collecting devices 110 may each connect to the network server 116 through the network gateways 114. Because each data collecting device 110 connects to some or all of the other data collecting devices 110 and because at least some of the data collecting devices 110 connect to the network gateway 114, data from each data collecting device 110 is able to be sent to the network gateway 114, whether directly (i.e., through direct transmission between the data collecting device 110 and the network gateway 114 through the network 112) or indirectly (e.g., from a further data collecting device 110 through the network to the data collecting device 110a to the network gateway 114a through the network 112).

According to an embodiment, each data collecting device 110 transmits environmental data to one or more other data collecting devices 110 over the network 112. The data collecting device 110 may receive additional environmental data from the other data collecting devices 110 over the network 112. The low-power processing module in the data collecting device 110 may be configured to merge the environmental data with the additional environmental data to form merged environmental data for transmitting over the network 112.

In an embodiment, the data collecting device 110 directly senses environmental data and further receives environmental data sensed by the other device 110. Thereafter, the device 110 may transmit the directly sensed environmental data and the received environmental data to the network 112. The foregoing process may be repeated until the collection of environmental data sensed by the plurality of data collecting devices 110 is delivered to the network gateway 114. Various network protocols may be used to transmit data within or from the data collecting devices 110. Preferably, low-powered network protocols including LoRa and LoRaWAN are used for transmission of the environmental data. In an embodiment, the merged environmental data includes environmental data as received from the other data collecting devices 110.

The environmental data may relate to the presence or absence of wildfire in the vicinity of the data collecting device 110. The environmental data may be processed within the data collecting device 110. Thereafter, the processed environmental data may be transmitted over the network 112. The data collecting device 110 may transmit the environmental data over the network 112. The data collection may receive related data, information, or instructions from the network 112.

The data collecting device 110 includes a plurality of sensors for collecting the environmental data and a filter for protecting the plurality of sensors. The plurality of sensors may be grouped in the sensor assembly within the data collecting device. The sensors may be configured as low-power data collecting devices for ultra-early wildfire detection. The sensors may detect environmental conditions, such as the presence/absence of elements associated with fire such as carbon dioxide, carbon monoxide, nitrogen dioxide, temperature, and/or humidity. In an embodiment, the filter is removeable.

The data collecting device 110 is configured to operate on a plurality of modes of operation or data transmission or network protocols. The wireless communication module may be configured to provide multiple modes of operation or data transmission or network protocols. The plurality of modes of operation may include LoRa end-node, LoRaWAN end-node, LoRa repeater mode, and LoRa to LoRaWAN mode. The modes of operation may represent various interoperability operations and utilities such as low battery consumption (LoRa), long-distance communication (LoRaWAN), extending communications (repeater mode), and interoperability between LoRa and LoRaWAN protocols, respectively. The data collecting device 110 may select the mode of operation or data transmission based on the location of the device 110 in the network 112. The data collecting device 110 may automatically select the mode based on the protocol through which data is received. For example, a LoRa mode may be selected on receiving a LoRa message or a LoRaWAN mode may be selected on receiving a LoRaWAN message.

According to an embodiment, the network gateways 114 may be configured as a LoRaWAN gateway 114. Where one of the data collecting devices 110 receives only a LoRaWAN message from a LoRaWAN gateway 114 (i.e., has a direct connection to the gateway 114), the data collecting device 110 selects a mode corresponding to a LoRaWAN end-node mode. Similarly, the data collecting device may select the LoRaWAN end-node mode on receiving a LoRaWAN message from a neighboring data collecting device. In the LoRaWAN end-node mode, the data collecting device 110 collects sensor data from sensors (not shown) within the data collecting device 110 for transmission over the network 112 via a further LoRaWAN message.

If the data collecting device 110a receives a LoRaWAN message from a LoRaWAN Gateway and further receives a LoRa message from the data collecting device 110b, the data collecting device 110a selects a LoRa to LoRaWAN mode. In the LoRa to LoRaWAN mode, the data collecting device 110a receives data from the data collecting device 110b via LoRa messages (i.e., receives data collected by the sensors of the data collecting device 110b) and merges data from the sensors of the data collecting device 110a with the received data from the data collecting device 110b for transmission over the network 112 in the LoRaWAN protocol to be received by the gateway 114. Merging the data may include aggregating the data of the device 110a with the device 110b without altering or compressing the data of the device 110a or the data of the device 110b. Merging the data may include pre-processing, altering, compressing, or post-processing the data of the device 110a or the data of the device 110b.

If the data collecting device 110 receives only LoRa messages from other devices 110, the data collecting device 110 selects a LoRa repeater mode. In the LoRa repeater mode, the data collecting device 110 receives data from the other devices 110 via LoRa messages (i.e., receives data collected by the sensors of the other data collecting devices 110) and merges data from the sensors of the other devices 110 with data from sensors of the device 110 for transmission via LoRa messages over the network 112.

If one of the data collecting devices 110 is located at an end of the network 112 away from any network gateway 114, then the data collecting device 110 may transmit data from its own sensors over LoRa messages to one or more other data collecting devices 110. Further, if the data collecting device does not need to repeat the environmental data and does not have direct access to any LoRaWAN Gateway 114, then the data collecting device 110 may transmit data from its own sensors over LoRa messages to one or more other data collecting devices 110.

The processing station 117 may be integrated in the network server 116 as shown in FIG. 1. The processing station 117 provides data services including sending, receiving, analyzing, and processing data received from the network gateways 114. The processing station 117 may perform advanced data processing techniques including machine learning algorithms and data fusion to detect and verify wildfire incidents. When the processing station 117 confirms that a wildfire has occurred, the processing station 117 generates alerts and notifications for relevant authorities to respond promptly and effectively to the incident.

The processing station 117 may be connected to the network 112 and the plurality of application servers 118 and terminals 120 for running wildfire detection applications. The application server 118 may be configured as a middleware between the processing station and the terminals 120 for running wildfire detection applications. The application server 118 may provide services including web application hosting, resource management, connection pooling, memory allocation, load balancing, data transaction management, data access, application logic, database management, business logic processing, interoperability services, application programming interface (API) integration, and security such as encryption and data authentication.

The terminals 120 include computer terminals for accessing the processed data from the wildfire detection system 100, for example outputs of the processing station 117 transmitted through the application servers 118. The terminals 120 may include mobile devices, smartphones, tablets, desktop computers, laptops, thin clients, kiosks, data processing terminals, and workstations.

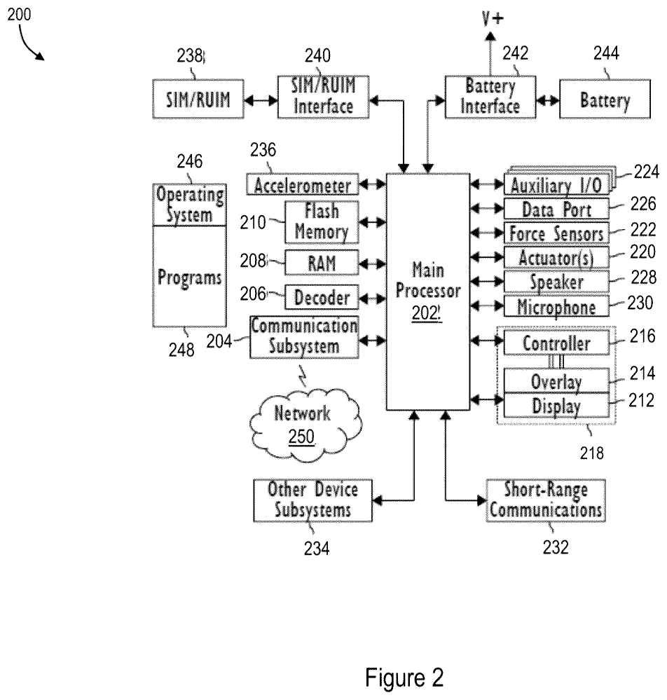

Referring now to FIG. 2, shown therein is a simplified block diagram of components of a device 200, according to an embodiment. The device 200 may correspond to any of the data collecting devices 110 shown in FIG. 1. The device 200 includes a processor 202 that controls the operations of the device 200. The processor 202 may be a low-power processing module in the data collecting device 110. Communication functions, including data communications, voice communications, or both may be performed through a wireless communication subsystem 204. The communication subsystem may be a wireless connection module in the data collecting device 110. The communication subsystem 204 may receive messages from, and send messages to, a wireless network 250. The wireless network may be the network 112 in FIG. 1. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting to one or more rechargeable batteries 244. The device 200 may include a power supply assembly (not shown). The device 200 may further include one or more non-rechargeable batteries (not shown).

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

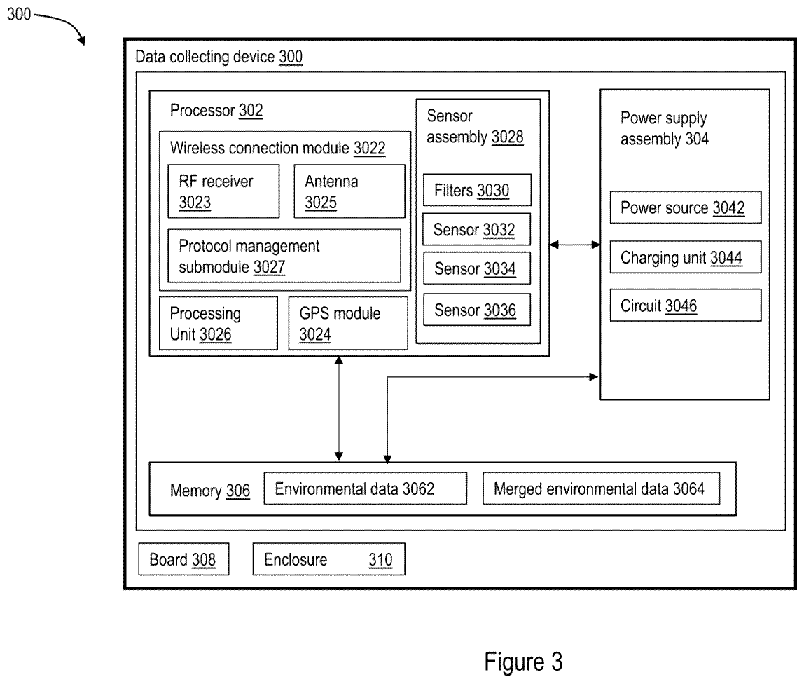

Referring now to FIG. 3, shown therein is a block diagram of a data collecting device 300 for early detection and monitoring of wildfires, according to an embodiment. The data collecting device 300 may be a data collecting device 110 of FIG. 1.

The data collecting device 300 includes a processor 302, a power supply assembly 304, a memory 306, a board 308 for providing circuits, and an enclosure 310 for providing protective cover to components of the device 300.

The processor 302 includes a wireless connection module 3022 for providing connectivity services, a global positioning system (GPS) module 3024 for providing location information, a processing unit 3026 to execute instructions, and a sensor assembly 3028 including a plurality of sensors 3032-3036. The sensors 3032-3036 may be connected to a plurality of filters 3030 to improve accuracy and reliability of the measured data. The processing unit 3026 may be configured as a low-power processing module.

The power supply assembly 304 may include a power source 3042 to store and provide electrical power, a charging unit 3044 to charge the power source, and a circuit 3046 to provide control of the electrical current. The charging unit 3044 may include a solar charging apparatus including a solar panel.

The wireless connection module 3022 may be configured to connect the data collecting device 300 to the wildfire detection network 112 of FIG. 1 to enable wireless data transmission and reception therebetween. The wireless connection module 3022 may connect to the network gateway 114 and other data collecting devices in the wildfire detection network 112.

The wireless connection module 3022 may include a radio frequency receiver 3023 to transmit and receive signals at specific radio frequencies and at specific time intervals. The wireless connection module 3022 may be configured to convert received radio frequency signals into digital data that may be processed by the low-power processing unit 3026. The wireless connection module 3022 includes an antenna 3025 configured to convert the signals into electromagnetic waves for transmission. The wireless connection module 3022 may be configured to connect the components within the data collecting device 300, including the processor 302, sensor assembly 3028, power supply assembly 304, and memory 306.

In an embodiment, in addition to the wireless communication module 3022, the data collecting device 300 includes a wired communication module (not shown) suitable to communicate with other data collecting devices 300 and the network gateway 114 over a hybrid network 112 as discussed in FIG. 1. Alternatively, a wired network 112 may be provided wherein the data collecting device 300 may include a wired communication module (not shown) configured to communicate with other data collecting devices 300 and the network gateway 114.

The wireless connection module 3022 is configured to transmit data collected by sensors 3032-3036 to the network gateway 114 or other data collecting devices 300 within the wildfire detection system 100. The wireless connection module 3022 may connect the data collecting device 300 to the network 112. The wireless connection module 3022 may also provide services including packet formation, error checking, encryption and addressing. The wireless connection module 3022 may provide network management tasks, including discovery of data collecting devices 300, configuration of the wildfire detection network 112, and maintaining connections with other data collecting devices 300.

The wireless connection module 3022 may also be configured to manage communication protocols such as Wi-Fi™, Zigbee™, Bluetooth™, LoRa and LoRaWAN to facilitate secure data transmission with low power consumption. In an embodiment, the wireless connection module 3022 is configured as a LoRa wireless connection module and/or or a LoRaWAN connection module.

The data collecting device 300 is configured to operate in a plurality of modes of operation or data transmission. The plurality of modes include LoRa end-node, LoRaWAN end-node, LoRa repeater mode, and LoRa to LoRaWAN mode. The modes of operation may represent various interoperability operations and utilities such as low battery consumption (LoRa), long-distance communication (LoRaWAN), extending communications (repeater mode), and interoperability between LoRa and LoRaWAN protocols, respectively. The protocol management submodule 3027 in the data collecting device 300 may automatically select the mode based on the location of the device 300 in the network 112. The protocol management submodule 3027 may automatically select the transmission mode based on the protocol through which the data is received. For example, a LoRa mode may be selected on receiving a LoRa message or a LoRaWAN mode may be selected on receiving a LoRaWAN message. The wildfire detection system may include low power dynamic wireless sensor networks.

LoRa (Long Range) includes a digital wireless data communication technology that utilizes low frequency radio frequency bands and modulation techniques to provide long-range communication and low power consumption. The LoRa protocol may address the physical layer of communication and format the data sent and received between the data collecting devices 300. LoRaWAN (Long Range Wide Area Network) includes a standardized protocol built upon LoRa technology providing higher abstraction. The LoRaWAN protocol may include both the communication protocol and system architecture for a LoRa-based network to enable efficient, secure, scalable data transmission between data collecting devices 300 and network gateways 114.

The wireless connection module 3022 may include a protocol management submodule 3027. To enable low-power functionality, the protocol management submodule 3027 may be configured to provide protocol management for LoRa and LoRaWAN data transmission protocols, including providing services for each protocol. The services may include packet formation, error checking, device detection, addressing, and encryption. The protocol management submodule 3027 may format the data collected by the sensors into packets in accordance with LoRa or LoRaWAN specifications based on requirements of the network 112. Such formatting includes adding headers, metadata and control information for proper routing and processing by the network gateway 114 or other devices of the system 100. The LoRaWAN protocol may rely on error checking mechanisms such as Cyclic Redundancy Check (CRC) or Forward Error Correction (FEC) to detect and correct errors during data transmission. The protocol management submodule 3027 may be configured to implement the error checking and provide data integrity and reliability information. Further, the LoRaWAN protocol may utilize device identifiers (DevEUI) and network identifiers (NetID) to address data collecting devices on the wildfire detection network. The protocol management submodule 3027 may be configured to manage an addressing scheme therefor and to provide data transmission between data collecting devices 300 and routing within the system 100. Furthermore, the LoRaWAN protocol may utilize an adaptive data rate mechanism that adjusts data rates and transmission power of the devices 300 based on distance of each device 300 from the gateway 114 and further based on conditions of the network 112. The protocol management submodule 3027 may be configured to manage this feature, optimizing energy consumption and network capacity.

To provide security services, the protocol management submodule 3027 may be configured to implement security features of LoRaWAN or LoRa security features. The protocol management submodule 3027 may be configured to implement encryption mechanisms such as Advanced Encryption Standard (AES) with a 128-bit key to protect sensitive information from unauthorized access.

The protocol management submodule 3027 may be configured to perform network and protocol related tasks, including device activation and joining procedures and acknowledging and processing messages sent from the network gateway 114.

The protocol management submodule 3027 may also provide for and/or enable optimized power consumption to save energy and extend battery life of each device 300. Such optimized power consumption includes time-synchronization and entering low-power modes when each device 300 is not actively transmitting or receiving data. The protocol management submodule 3027 may be configured to operate the time synchronization with respect to each of sensors 3032-3036. The sensors 3032-3036 and processing unit 3026 may be optimized for reduced power consumption through time synchronization techniques. Techniques including duty cycling, time-slotted communication, coordinated sensing, power-efficient routing, and reduced idle listening may be used. The processing unit 3026 may be configured to activate data collection in the sensors 3032-3036 at predefined time schedules and enter low-power inactive modes outside of the predefined time schedules and/or cause the sensors 3032-3036, the radio-frequency (RF) receiver 2023, and the antenna 3025 to enter low-power inactive modes outside the predefined time schedules. Similarly, the protocol management submodule 3027 may be configured to receive and transmit environmental data at predefined time schedules and alternatively enter low-power inactive modes.

The processing unit 3026 may be configured as a low-power processing module. The low-power processing module 3026 may be connected to the wireless connection module 3022 and other components of the data collecting device 300. The low-power processing module 3026 may be configured to receive data from the sensor assembly 3028 and the GPS module 3024. The low-power processing module 3026 may process or merge the data and communicate the processed data to the network 112 through the wireless connection module 3022.

The low-power processing module 3026, may be configured as low-power computing systems configured to execute instructions stored in memory 306 or on other similar storage devices. The instructions may include one or more separate programs, which may comprise an ordered listing of executable instructions for implementing logical functions. The low-power processing module 3026 may control the execution of other computer programs and provides scheduling, input-output control, file and data management, memory management, and communication control and related services.

The filters 3030 may be used to provide protection to the plurality of sensors 3032-3036 and enhance performance, improve measurement accuracy, and protect the sensors 3032-3036 from interfering signals. The filters 3030 may include bandpass filters to allow a specific wavelength range of light to enter the sensors, neutral density filters to attenuate the intensity of light entering the sensor, chemical filters to allow selective detection of gases, particulate filters to prevent solid particles, dust, or aerosols from interfering with the sensing process, hydrophobic filters to prevent the ingress of water vapor or liquid water, moisture control filters to control humidity levels, and/or temperature control filters.

Data sensed by the sensors 3032-3036 is stored in the memory 306 as environmental data 3062. The environmental data 3062 may thereafter be transmitted to the low-power processing module 3026. Detection by the sensors 3032-3036 is configured to collect and monitor the environmental data 3062 to facilitate detection of conditions suggesting wildfire. The conditions may include detecting, identifying, and measuring the environmental data 3062 in proximity to the sensors 3032-3036 such as chemicals, gases, and physical conditions such as temperature and humidity. When environmental data 3062 received at a device 300 from a different device 300 is merged with environmental data 3062 collected at the device 300, such merged data is stored in the memory 306 as merged data 3064. The plurality of sensors 3032 to 3036 are configured for low power consumption and provide ultra-early wildfire detection using time synchronization as hereinabove described. The sensors 3032-3036 detect environmental conditions, such as the presence/absence of elements associated with fire such as carbon dioxide, carbon monoxide, nitrogen dioxide, temperature, and/or humidity in the vicinity of the data collecting device. The conditions may include temperature, humidity, smoke, or infrared radiation. A temperature sensor (e.g., the sensor 3032) may include a thermistor or thermocouple to measure the ambient temperature in a surrounding environment. When the temperature sensor 3032 records a sudden increase in temperature or once a predefined threshold is exceeded, this may indicate fire activity. A humidity sensor (e.g., the sensor 3034) may detect air humidity and moisture levels in the environment close to the sensor. A low humidity level may indicate a risk of wildfire.

A smoke sensor (e.g., the sensor 3036) may include optical, photoelectric, ionization, or other types of sensors configured to detect the presence of smoke particles in the air. The presence of smoke may indicate a wildfire. Further, a gas sensor (e.g., the sensor 3036) may detect the presence of combustion gases. The gas sensor 3036 may be configured to detect carbon monoxide (CO) or volatile organic compounds (VOCs) that may be produced during a fire. Humidity data may be combined with other sensor data to assess the likelihood of a wildfire occurring. The sensors 3032-3036 may further detect wind speed and direction.

The data collecting device 300 includes a power supply assembly 304 to provide electrical power to the components of the data collecting device 300.

The power supply assembly 304 includes a power source 3042 to store and provide electrical power, a charging unit 3044 to charge the power source, and a circuit 3046 to provide control of the electrical current. The charging unit 3044 may include a solar charging apparatus including a solar panel.

In an embodiment, the power source 3042 includes a plurality of batteries. The power source includes a non-rechargeable and a rechargeable battery. The rechargeable battery may be a solar cell. The plurality of batteries may include rechargeable batteries and high-capacity non-rechargeable batteries. The power supply assembly 304 may further include a power collection apparatus (not shown). The power collection apparatus may include a solar cell for charging the plurality of batteries. The rechargeable battery may serve as a first power source until an energy level of the rechargeable battery reaches a predetermined limit. The non-rechargeable battery may serve as a second power source when the energy level is at the predetermined limit until the rechargeable battery is recharged so that the energy level is not at the predetermined limit.

The power management circuit 3046 may be configured as a smart power management circuit. The smart power management circuit 3046 may recharge a battery of the charging unit 3044 until the battery capacity drops below a threshold (e.g., 30%). At that point, the circuit 3046 may switch to a high-capacity non-rechargeable battery until the rechargeable battery recharges to a predetermined threshold (80%). This feature reduces power consumption of the device 300. Furthermore, the circuit 3046 may optimize warm-up times of the sensors 3042-3046 and intervals in data transmission between the data collecting devices 300 and the intervals of data collection by the sensors.

The board 308 may have a modular design so that further sensors (not shown) may be integrated or removed. The board may be configured to receive the filter 3030. In an embodiment, the filter 3030 is a removable gas filter.

The data collecting device 300 may be physically enclosed in a protective enclosure 310.

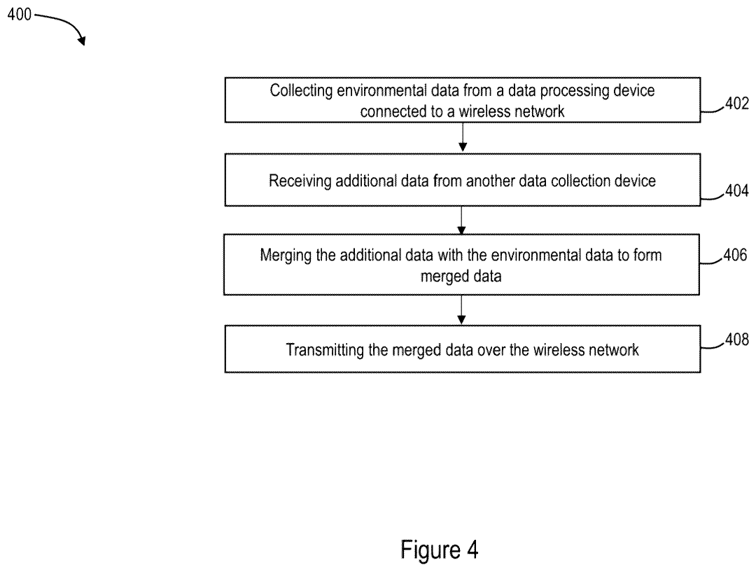

Referring now to FIG. 4, shown therein is a flow diagram of a method 400 for early detection and monitoring of wildfires, according to an embodiment.

At 402, environmental data is collected from a data collecting device connected to a wireless network. The data collecting device may be the data collecting device 110 of FIG. 1 connected to the network 112 of the system 100. The data collecting device may be the data collecting device 300 of FIG. 3.

At 404, additional data from a neighboring data collecting device is received. In an embodiment, the neighboring data collecting device is a different data collecting device 110 or 300. The additional environmental data may include the environmental data sensed by the neighboring data collecting device 110 or 300. The additional environmental data may include the environmental data received by the neighboring data collecting device 110 or 300 from another data collecting device 110 or 300.

At 406, the additional data received from the neighboring data collecting device is merged with the environmental data sensed by the data collecting device to form merged data. In an embodiment, the processing unit 3026 merges the environmental data from the sensors 3032-3036 with the additional data from the neighbouring data collecting devices 300 (whether collected by the sensors 3032-3036 of the neighbouring devices 300 or received from still other devices 300) to form the merged data.

A first data collecting device may sense and process environmental data locally. Thereafter, the first data collecting device may receive processed environmental data from a second device. The first data collecting device may provide data packaging operations to merge environmental data sensed thereby with the additional environmental data collected from the neighboring device. The data packaging operations may include format change, protocol optimization, data encoding, data encapsulation, data segmentation, and data compression. Such a collaborative approach between and among the data collecting devices provides coverage over a larger area, improves data accuracy, and increase the reliability of the overall system.

At 408, the merged data is transmitted over a network. In an embodiment, the processing unit 3026 transmits the merged data through the wireless connection module 3032. In an embodiment, the merged data is transmitted to the network gateway 114. The network gateway 114 may perform additional processing and analysis. The environmental data is transmitted to the network server 116 or processing station 117 for additional processing and aggregation. The data is received by the application servers 188, where the data may be visualized, monitored, or used for decision-making purposes. The data may ultimately be received by the terminals 120.

Each component of the system may receive related data, information, or instructions from the network.

The low-powered wildfire detection system provides energy efficiency, extended operational life, scalability, and improved communication. Interoperability across a variety of network protocols is achieved and provides enhanced effectiveness and versatility of the system. Devices using different protocols may communicate with one another effectively. As a result, various protocols may be implemented in the network infrastructure providing simplified integration, scalability, enhanced reliability, fault tolerance, and cost savings. By providing time synchronization, power consumption is reduced. The sensors may collect environmental data at predetermined time schedules, obviating the need of keeping the antennas active for longer duration. As a result, the sensors may operate for longer periods without requiring battery replacement or recharging. The sensors may operate in a synchronized manner leading to efficient network management, improved sensor collaboration, and enhanced data accuracy. The optimized power supply including rechargeable and non-rechargeable batteries may provide further advantages via extended device operation time, reliability, and improved performance. The power supply redundancy, including consumption of a solar powered rechargeable battery until the power levels in battery are critically low and then shifting to a non-rechargeable battery until the rechargeable battery is at least partially recharged, provides for flexible power management and power adaptability.

Referring now to FIG. 5, shown therein is a top view of a system for early wildfire detection in deployment, according to an embodiment. The system 500 includes a plurality of data collecting devices 502 disposed in a mesh topology. In the interest of clarity, not all the data collecting devices 502 are labelled in FIG. 5, but it will be appreciated that like symbols are all data collecting devices 502. The data collecting devices 502 may be the data collecting devices 110 of FIG. 1 or the data collecting devices 300 of FIG. 3.

Advantageously, each device 502 may communicate with network gateways (not shown) in FIG. 5 according to multiple paths. Therefore there is redundancy in the deployment shown in FIG. 5 because the deactivation of any one device 502 does not impede the system 500. For example, if one or both of the two sensors marked 502 were rendered non-functional (e.g., destroyed by wildlife), neighbouring devices 502 thereto may advantageously continue to transmit collected environmental data along a different and previously redundant path to a network gateway.

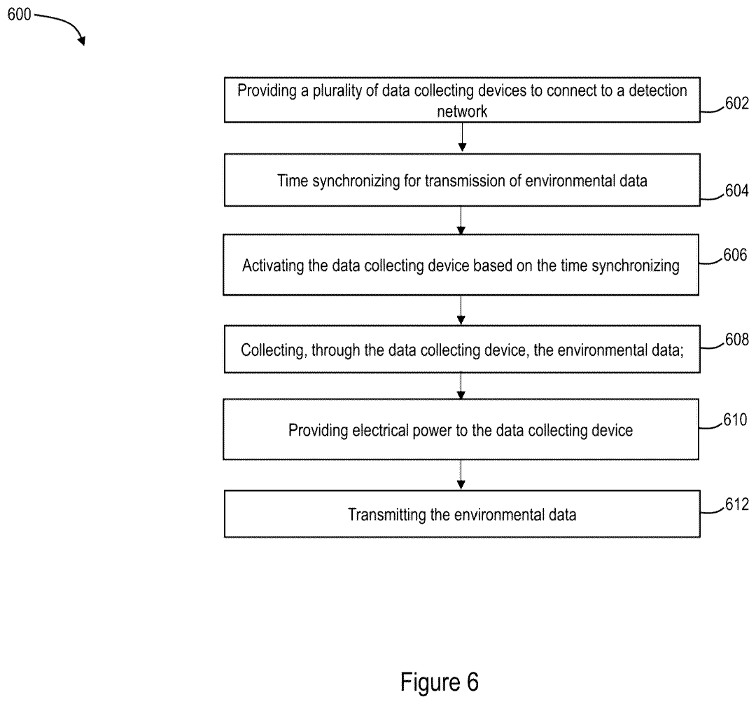

Referring now to FIG. 6, shown therein is a detection method 600.

At 602, the detection method 600 includes providing a plurality of data collecting devices to connect to a detection network, the plurality of data collecting devices configured to operate in any one of a plurality of network protocols.

At 604, the detection method 600 includes time synchronizing for transmission of environmental data.

At 606, the detection method 600 includes activating the data collecting device based on the time synchronizing.

At 608, the detection method 600 includes collecting, through the data collecting device, the environmental data.

At 610, the detection method 600 includes providing electrical power to the data collecting device including providing a power source and a power management circuit. The power source includes a rechargeable battery and a non-rechargeable battery. The rechargeable battery serves as a first power source until an energy level of the rechargeable battery reaches a predetermined limit according to the power management circuit. The non-rechargeable battery serves as a second power source when the energy level is at the predetermined limit.

At 612, the detection method 600 includes transmitting the environmental data.

References to a low-power processing unit, such as the low-power processing unit, represent low-power computing devices or computer systems capable of executing software including instructions stored in memory or on other similar storage devices. The instructions may include one or more separate programs, each of which includes an ordered listing of executable instructions for implementing logical functions. The unit may control the execution of other computer programs and provides scheduling, input-output control, file and data management, memory management, and communication control and related services.

Additionally, it should be understood that the disclosed subject matter may be implemented as a system, a method, and/or a computer program product at any possible technical detail level of integration. The computer program product may include a computer readable storage medium (or media) having computer readable program instructions thereon for causing a processor to carry out embodiments and features of the subject disclosure.

References to an “app”, “application”, or a “software application” may refer to a computer program or group of programs designed for end users. The terms may encompass standalone applications, thin client applications, thick client applications, web-based applications, such as a browser, and other similar applications.

Computer readable storage mediums, as described herein, may be a tangible device that retains and stores instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk™, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to exploit features of the present disclosure.

Embodiments and features of the subject disclosure are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, devices, and computer program products according to various embodiments of the subject disclosure.

In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The detailed description provided above in connection with the appended drawings explicitly describes and supports various features of a system, method, and device for early wildfire detection. By way of illustration and not limitation, supported embodiments include a data collecting device for wildfire detection, the data collecting device including a wireless connectivity module for connecting to the wildfire detection network, a low-power processing unit for connecting to the wireless connectivity module, a sensor assembly for sending environmental data to the low-power processing unit with the sensor assembly having a plurality of sensors for collecting the environmental data and a filter for protecting the plurality of sensors, and a power supply assembly for supplying power to the plurality of sensors with the power supply assembly having a power source and a power management circuit.

Supported embodiments include the foregoing data collecting device, wherein the plurality of sensors include sensors selected from the group consisting of carbon monoxide sensors, carbon dioxide sensors, nitrogen dioxide sensors, temperature sensors, and humidity sensors.

Supported embodiments include any of the foregoing data collecting devices, wherein the wireless connectivity module is configured for connecting to a low power wide area network.

Supported embodiments include any of the foregoing data collecting devices, further comprising a GPS module.

Supported embodiments include any of the foregoing data collecting devices, wherein the power source includes a plurality of batteries.

Supported embodiments include any of the foregoing data collecting devices, wherein the plurality of batteries include rechargeable batteries and high capacity non-rechargeable batteries.

Supported embodiments include any of the foregoing data collecting devices, further comprising a solar cell for charging the plurality of batteries.

Supported embodiments include any of the foregoing data collecting devices, wherein the power management circuit is a smart power management circuit.

Supported embodiments include any of the foregoing data collecting devices, further comprising: an enclosure for holding the wireless connectivity module, the low-power processing unit, the sensor assembly, and the power supply assembly.

Supported embodiments include any of the foregoing data collecting devices, wherein the filter is removable.

Supported embodiments include any of the foregoing data collecting devices, wherein the data collecting device is one of a plurality of data collecting devices within the wildfire detection system.

Supported embodiments include any of the foregoing data collecting devices, wherein the data collecting device transmits the environmental data to another data collecting device within the wildfire detection system.

Supported embodiments include any of the foregoing data collecting devices, wherein the data collecting device receives additional environmental data from another data collecting device within the wildfire detection system.

Supported embodiments include any of the foregoing data collecting devices, wherein the low-power processing unit merges the data collecting device environmental data with the additional environmental data to form merged environmental data for transmitting over a network within the wildfire detection system.

Supported embodiments include any of the foregoing data collecting devices, wherein the wildfire detection system includes a gateway and the data collecting device connects to the gateway within the wildfire detection system.

Supported embodiments include an apparatus, a system, a method, a device, a computer-readable storage medium, a computer program product and/or means for implementing any of the foregoing data collecting devices or portions thereof.

The detailed description provided above in connection with the appended drawings is intended as a description of examples and is not intended to represent the only forms in which the present examples may be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein may represent one or more of any number of processing strategies. As such, various operations illustrated and/or described may be performed in the sequence illustrated and/or described, in other sequences, in parallel, or omitted. Likewise, the order of the above-described processes may be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

1. A detection system comprising:
a plurality of data collecting devices in a detection network, the data collecting device comprising:
a wireless communication module configured to:
connect to the detection network;
operate in any one of a plurality of network protocols;
provide time synchronization for transmission of environmental data; and
transmit the environmental data;
a power processing module configured to:
activate a sensor assembly at a preset sensor time period based on the time synchronization;
according to the time synchronization, communicate the environmental data from the sensor assembly to the wireless communication module;
the sensor assembly configured to collect the environmental data; and
a power supply assembly configured to provide electrical power to the data collecting device, the power supply assembly including a power source and a power management circuit, wherein the power source includes a rechargeable battery and a non-rechargeable battery, the rechargeable battery serves as a first power source until an energy level of the rechargeable battery reaches a predetermined limit according to the power management circuit, and the non-rechargeable battery serves as a second power source when the energy level is at the predetermined limit.

2. The detection system of claim 1, wherein a network protocol is automatically selected from the plurality of network protocols based on a location of the data collecting device and/or a received network protocol received from another data collecting device.

3. The detection system of claim 1, wherein the non-rechargeable battery serves as the second power source until the rechargeable battery is recharged such that the energy level is not at the predetermined limit.

4. The detection system of claim 1 further comprising:
at least one network gateway configured to provide a communication interoperability interface between the plurality of network protocols;
a network server for providing network services including data processing, storage, application and device management, and resource sharing, the network server connected to the at least one network gateway;
wherein the plurality of network protocols includes any one or more of a LoRa (Low Range) network protocol and a LoRaWAN (Low Range Wide Area Network) network protocol, and wherein the environmental data relates to the presence or absence of a wildfire; and
wherein the sensor assembly includes a filter configured to improve measurement accuracy, the filter configured as any one or more of a bandpass filter, a neutral density filter, a chemical filter, and a particulate filter.

5. The detection system of claim 1, wherein the time synchronization includes any one or more of duty cycling, time-slotted communication, coordinated sensing, power-efficient routing, and reduced idle listening.

6. The detection system of claim 1, wherein the sensor assembly includes a plurality of sensors configured to detect the environmental data, the environmental data relating to any one or more of carbon dioxide, carbon monoxide, nitrogen dioxide, temperature, and humidity.

7. The detection system of claim 2, wherein the wireless communication module is configured to operate in any one of a plurality of operation modes including a LoRa end-node, a LoRaWAN end-node, a LoRa repeater mode, and a LoRa to LoRaWAN mode based on the received network protocol of the other data collecting device.

8. A detection method, the method including:
providing a plurality of data collecting devices to connect to a detection network, the plurality of data collecting devices configured to operate in any one of a plurality of network protocols;
time synchronizing for transmission of environmental data;
activating the data collecting device based on the time synchronizing;
collecting, through the data collecting device, the environmental data;
providing electrical power to the data collecting device including providing a power source and a power management circuit, wherein the power source includes a rechargeable battery and a non-rechargeable battery, the rechargeable battery serves as a first power source until an energy level of the rechargeable battery reaches a predetermined limit according to the power management circuit, and the non-rechargeable battery serves as a second power source when the energy level is at the predetermined limit; and
transmitting the environmental data.

9. The detection method of claim 8, further comprising automatically selecting a network protocol from the plurality of network protocols based on a location of the data collecting device and/or a received network protocol received from another data collecting device.

10. The detection method of claim 8, wherein the non-rechargeable battery serves as a second power source until the rechargeable battery is recharged such that the energy level is not at the predetermined limit.

11. The detection method of claim 8 further comprising:
providing a communication interoperability interface between the plurality of network protocols;
providing network services including data processing, storage, application and device management, and resource sharing;
wherein the plurality of network protocols includes any one or more of a LoRa (Low Range) network protocol and a LoRaWAN (Low Range Wide Area Network) network protocol; and
wherein the environmental data relates to the presence or absence of a wildfire.

12. The detection method of claim 8, wherein the time synchronization includes any one or more of duty cycling, time-slotted communication, coordinated sensing, power-efficient routing, and reduced idle listening.

13. The detection method of claim 8, wherein the data collecting device includes a plurality of sensors configured to detect the environmental data, the environmental data relating to any one or more of carbon dioxide, carbon monoxide, nitrogen dioxide, temperature, and humidity.

14. The detection method of claim 9, wherein the data collecting device is configured to operate in any one of a plurality of operation modes including a LoRa end-node, a LoRaWAN end-node, a LoRa repeater mode, and a LoRa to LoRaWAN mode based on the received network protocol received from the other data collecting device.

15. A detection device comprising:
a wireless communication module configured to:
connect to a detection network;
operate in any one of a plurality of network protocols;
provide time synchronization for transmission of environmental data; and
transmit the environmental data;
a power processing module configured to:
activate a sensor assembly at a preset sensor time period based on the time synchronization;
according to the time synchronization, communicate the environmental data from the sensor assembly to the wireless communication module;
the sensor assembly configured to collect the environmental data; and
a power supply assembly configured to provide electrical power to the detection device, the power supply assembly including a power source and a power management circuit, wherein the power source includes a rechargeable battery and a non-rechargeable battery, the rechargeable battery serves as a first power source until an energy level of the rechargeable battery reaches a predetermined limit according to the power management circuit, and the non-rechargeable battery serves as a second power source when the energy level is at the predetermined limit.

16. The detection device of claim 15, wherein a network protocol is automatically selected from the plurality of network protocols based on a location of the detection device in the network and/or a received network protocol received from another detection device, and wherein the plurality of network protocols includes any one or more of a LoRa (Low Range) network protocol and a LoRaWAN (Low Range Wide Area Network) network protocol.

17. The detection device of claim 15, wherein the non-rechargeable battery serves as the second power source until the rechargeable battery is recharged such that the energy level is not at the predetermined limit.

18. The detection device of claim 15, wherein the time synchronization includes any one or more of duty cycling, time-slotted communication, coordinated sensing, power-efficient routing, and reduced idle listening.

19. The detection device of claim 15, wherein the sensor assembly includes a plurality of sensors configured to detect the environmental data, the environmental data relating to any one or more of carbon dioxide, carbon monoxide, nitrogen dioxide, temperature, and humidity.

20. The detection device of claim 16, wherein the wireless communication module is configured to operate in any one of a plurality of operation modes including a LoRa end-node, a LoRaWAN end-node, a LoRa repeater mode, and a LoRa to LoRaWAN mode based on the received network protocol received from the other detection device.
